(19) United States
(12) Patent Application Publication
(10) Pub. No.: US 2007/0146641 A1
(43) Pub. Date: Jun. 28, 2007

(54) ILLUMINATION SYSTEM AND OPTICAL PROJECTION APPARATUS

(75) Inventor: Sze-Ke Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/567,214

(22) Filed: Dec. 6, 2006

(30) Foreign Application Priority Data
Dec. 27, 2005 (TW) 94146682

(51) Int. Cl. G03B 21/26

(52) U.S. Cl. 353/29; 353/94

(57) ABSTRACT

An illumination system including an optical element, a primary light source, an auxiliary light source, and a light guide element is provided. The primary light source and the auxiliary light source are disposed adjacent to the light incident end of the optical element. The primary light source provides a primary light beam, and the auxiliary light source provides an auxiliary light beam. The duration for the primary light source to reach the maximum light-emitting luminance is longer than that of the auxiliary light source. The light guide element is shifted in or away from the transmission path of the primary light beam, so that the illumination system provides an illumination light beam with an appropriate luminance. An optical projection apparatus having the above-described illumination system capable of promptly displaying images upon turning on is provided.

### CROSS-REFERENCE TO RELATED APPLICATION

This application claims the priority benefit of Taiwan application serial no. 94146682, filed Dec. 27, 2005. All disclosure of the Taiwan application is incorporated herein by reference.

### BACKGROUND OF THE INVENTION

1. Field of Invention

The present invention relates to an illumination system and an optical projection apparatus, and particularly to an illumination system with an auxiliary light source and an optical projection apparatus with the aforementioned illumination system.

2. Description of the Related Art

Due to the higher light-emitting efficiency, higher light collection efficiency, and longer lamp lifespan, the ultrahigh pressure mercury lamps (UHPs) have become the primary light source in most illumination systems of the common projectors or rear projection televisions (RPTV) available on the market today.

Referring to FIG. 1, it is a schematic diagram showing a relationship between the time and the degree of illumination (in % of total) of an ultra high pressure (UHP) mercury lamp after it is turned on. In general, an UHP requires a very long idling time. For example, from FIG. 1 it can be seen that at least five minutes after turning on an UHP are required for the degree of illumination to reach 100% (i.e. at fully-lit status). In other words, a conventional projector or rear projection television (RPTV) employing an UHP as the light source requires a longer time after it is turned on to initiate displaying of images on a screen, which brings an intolerable waiting period and tremendous inconvenience to the user. In particular, the long idling time is especially not acceptable to a user since it does not match the instant displaying of images when using a cathode ray tube television (CRT television), a liquid crystal display television (LCD television), or a plasma display panel television (PDP television), of which a user has grown accustomed to from his or her television watching experience. Indeed, the conventional projector or rear projection television (RPTV), unlike a TV set, have failed to meet user's demands in regards to the aforementioned aspect.

### SUMMARY OF THE INVENTION

The present invention is related to an illumination system to resolve the issue of a conventional illumination system failing to provide a fast enough illumination of an appropriate luminance after turning on.

The present invention is further related to an optical projection apparatus to resolve the issue of a conventional optical projection apparatus failing to provide a fast displaying of images after turning on.

To achieve the above-described advantages, the present invention provides an illumination system, which includes an optical element, a primary light source, an auxiliary light source, and a light guide element. In which, the optical element has an incident end, while the primary light source and the auxiliary light source are disposed at a side of the incident end of the optical element. The primary light source is suitable for providing a primary light beam, and the auxiliary light source is suitable for providing an auxiliary light beam. The duration of the primary light source to reach the maximum light-emitting luminance is longer than that of the auxiliary light source after turning on the primary light source. The light guide element is used for shifting in or away from the transmission paths of the primary light beam and the auxiliary light beam to enable the primary light beam or the auxiliary light beam to be transmitted to the optical element.

The present invention further provides an optical projection apparatus, which includes a light valve, an imaging system, and the above-described illumination system. In which, the light valve is disposed behind the optical element of the illumination system and is suitable for converting the incident primary light beam or the incident auxiliary light beam into an image light beam. The imaging system is disposed on the transmission path of the image light beam to project the image light beam onto a screen for producing the image frames. Taking advantage of the auxiliary light source of the present invention, which is able to provide an illumination light beam with an appropriate luminance after turning on of the illumination system, the drawback for a conventional optical projection apparatus for failing to promptly display images after turning on can be alleviated.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic diagram showing a relationship between the time and the degree of illumination (in % of total) of an ultra high pressure (UHP) mercury lamp after turning on the UHP mercury lamp.

FIG. 2A and FIG. 2B are schematic diagrams showing an optical projection apparatus according to a first embodiment of the present invention.

FIG. 3 is a schematic diagram showing a relationship between the time and the degree of illumination (in % of total) of an optical projection apparatus according to an embodiment of the present invention after turning on the illumination system.

FIG. 4A and FIG. 4B are schematic diagrams showing an optical projection apparatus according to a second embodiment of the present invention.

FIG. 5A and FIG. 5B are schematic diagrams showing an optical projection apparatus according to a third embodiment of the present invention.

FIG. 6 is a schematic diagram showing an optical projection apparatus according to a fourth embodiment of the present invention.

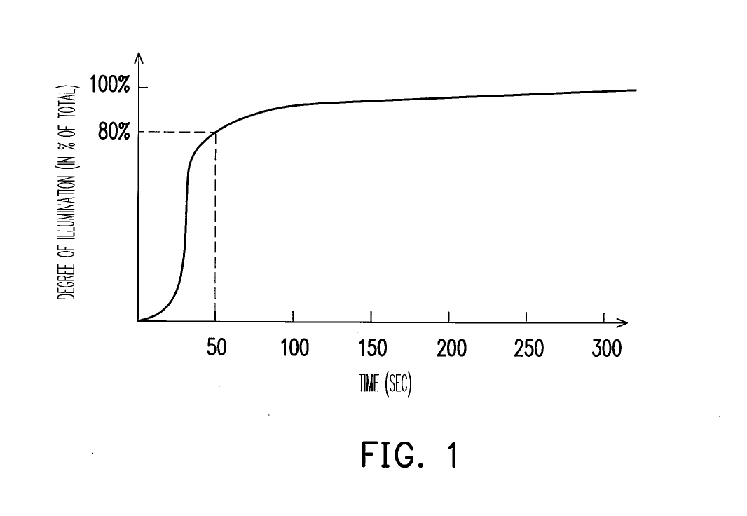

### DESCRIPTION OF THE EMBODIMENTS

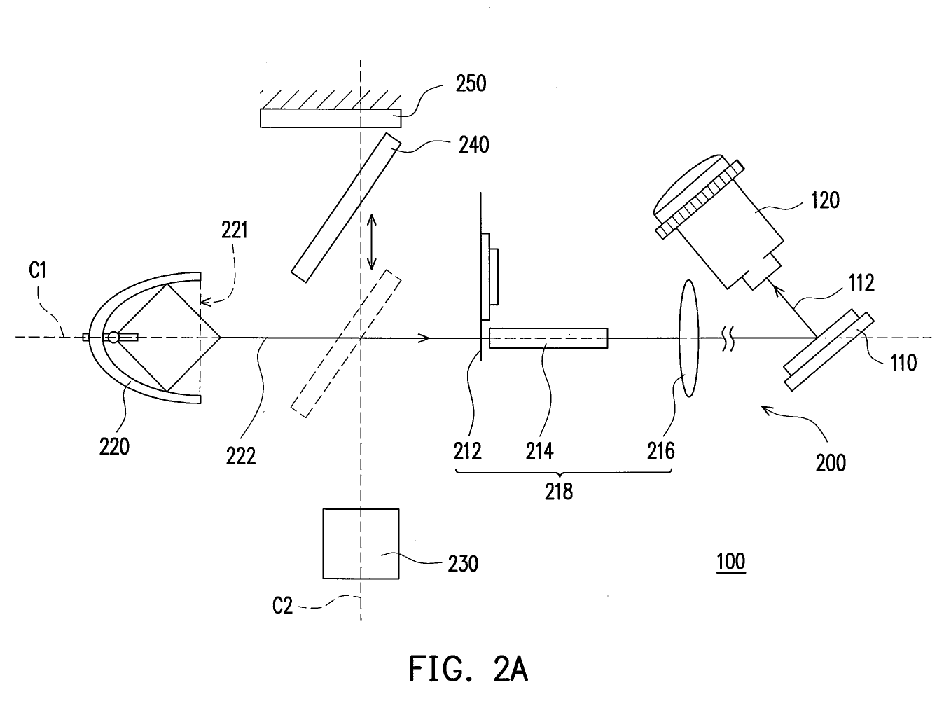

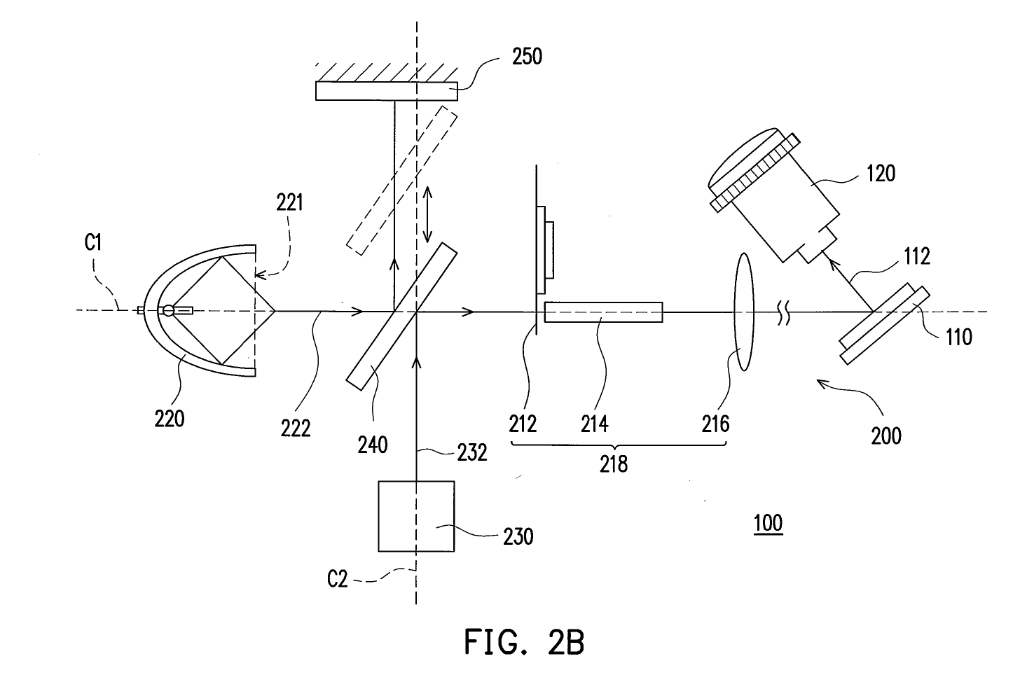

The First Embodiment FIG. 2A and FIG. 2B are schematic diagrams showing an optical projection apparatus according to a first embodiment of the present invention. Referring to FIGS. 2A and 2B, an optical projection apparatus 100 includes a light valve 110, an imaging system 120, and an illumination system 200. The light valve 110 is disposed between the imaging system 120 and the illumination system 200. The illumination system 200 includes a primary light source 220, an auxiliary light source 230, a light guide element 240, and at least an optical element 218 (such as a color wheel 212, a light integration rod 214, a lens 216, or a combination thereof). Each optical element 218 possesses a light incident end, and the primary light source 220 and the auxiliary light source 230 are disposed at a side of light incident end closest thereto, for example, at the side of the light incident end of the color wheel 212. The primary light source 220 possesses a light emitting section 221 opposite to the light incident end of the color wheel 212 and is suitable for providing a primary light beam 222 to be transmitted to the color wheel 212. The auxiliary light source 230 is suitable for providing an auxiliary light beam 232. The light guide element 240 is used for shifting in or away from the transmission paths of the primary light beam 222 and the auxiliary light beam 232, such that the primary light beam 222 or the auxiliary light beam 232 is able to be transmitted to the optical element 218. As the light guide element 240 is shifted in the transmission paths of the primary light beam 222 and the auxiliary light beam 232 (as shown in FIG. 2B), the light guide element 240 enables the auxiliary light beam 232 to be transmitted to the optical element 218 and the primary light beam 222 to be shifted away from the optical element 218. On the other hand, as the light guide element 240 is shifted away from the transmission paths of the primary light beam 222 and the auxiliary light beam 232 (as shown in FIG. 2A), the light guide element 240 enables the primary light beam 222 to be transmitted to the optical element 218 while the auxiliary light source 230 is turned off. In addition, the duration of the primary light source 220 to reach a maximum light-emitting luminance is longer than that of the auxiliary light source 230. The light valve 110 is suitable for converting the incident primary light beam 222 or the incident auxiliary light beam 232 into an image light beam 112. The imaging system 120 is disposed on the transmission path of the image light beam 112 for projecting the image light beam onto a screen for producing an image.

In the optical projection apparatus 100, the maximum light-emitting luminance of the primary light source 220 is, for example, higher than that of the auxiliary light source 230. The primary light source 220, the color wheel 212, the light integration rod 214, the lens 216, and the light valve 110 are disposed, for example, on a first axis C1, while the auxiliary light source 230 is located, for example, on a second axis C2. The first axis C1 is, for example, perpendicular to the second axis C2. Furthermore, the light guide element 240 moves along the second axis C2 for being shifted in or away from the transmission paths of the primary light beam 222 and the auxiliary light beam 232.

In the embodiment, the primary light source 220 is a light source having a longer idling time than that of the auxiliary light source 230. The primary light source is, for example, an ultra high pressure (UHP) mercury lamp or a xenon lamp. The auxiliary light source 230 is a light source without having idling time or requiring a shorter idling time than that of the primary light source 220. The auxiliary light source 230 is, for example, a light-emitting diode (LED), a halogen lamp, a metal halide lamp (MHL), or a laser diode (LD). Furthermore, the light guide element 240 is, for example, a reflector, a dichroic mirror, a prism, or a lens set and is connected, for example, to an actuator (not shown). The actuator is used for moving the light guide element 240 to a first position (as shown in FIG. 2A) or to a second position (as shown in FIG. 2B), in which the second position is the light guide element 240 being disposed on the transmission paths of the primary light beam 222 and the auxiliary light beam 232. The actuator is, for example, a motor. Note that although the light valve 110 in FIGS. 2A and 2B is a reflective-type light valve, such as a liquid crystal on silicon panel (LCoS panel) or a digital micro-mirror device (DMD), the light valve of the present invention is not limited to the above light valve types. In fact, the light valve 110 of the present invention can be a transmissive-type light valve such as a liquid crystal display panel (LCD panel) as well. The imaging system 120 is, for example, a projection lens.

In the first embodiment, the light guide element 240 is a reflector. As the optical projection apparatus 100 is turned on, the primary light source 220 and the auxiliary light source 230 are simultaneously turned on. At this time, since the primary light source 220 has insufficient light-emitting luminance, the light guide element 240 disposed on the second position (as shown in FIG. 2B) enables the primary light beam 222 to be shifted away from a plurality of optical elements 218 which includes the color wheel 212, the light integration rod 214, and the lens 216 by means of the reflection of the light guide element 240, while the auxiliary light beam 232 is transmitted to the optical elements 218 including the color wheel 212, the light integration rod 214, and the lens 216 by means of the reflection of the light guide element 240. Since the auxiliary light source 230, after being turned on, is able to reach the maximum light-emitting luminance in a very short duration (for example, in one second), the auxiliary light beam 232 provided by the auxiliary light source 230 is reflected by the light guide element 240 and then is passed through the optical elements 218 of the color wheel 212, the light integration rod 214 and the lens 216. Afterwards, the auxiliary light beam 232 is converted into an image light beam 112 by the light valve 110. The image light beam 112 is transmitted to the imaging system 120 to be projected onto the screen (not shown). Therefore, at the beginning after turning on the optical projection apparatus 100, the required illumination light beam of the optical projection apparatus 100 is provided by the auxiliary light source 230.

Afterwards, as the light-emitting luminance of the primary light source 220 gradually reaches to an extent higher than that of the auxiliary light source 230 or to a certain preset light-emitting luminance (for example, to 80% of the maximum light-emitting luminance thereof), the actuator moves the light guide element 240 to the first position (as shown in FIG. 2A), such that the primary light beam 222 is transmitted to a plurality of optical elements 218 which include the color wheel 212, the light integration rod 214, and the lens 216. Furthermore, the primary light beam 222 is converted into the image light beam 112 by the light valve 110. The image light beam 112 is transmitted to the imaging system 120 which enables the image light beam 112 to be projected onto the screen. In other words, only after a duration of time (for example, tens of seconds) after turning on the optical projection apparatus 100, the required illumination light beam of the optical projection apparatus 100 is provided by the primary light source 220. Along with the light guide element 240 moving to the first position by the actuator, the auxiliary light source 230 may be turned off.

In addition, as the optical projection apparatus 100 is turned off, the actuator moves the light guide element 240 to the second position (as shown in FIG. 2B), such that the light guide element 240 takes a ready position for the next turn to turn on the optical projection apparatus 100. The primary light beam 222 provided by the primary light source 220 is reflected by the light guide element 240 and is shifted away from the optical element 218, while the auxiliary light beam 232 provided by the auxiliary light source 230 is guided to the optical element 218.

In the embodiment, a thermal dissipation element 250 is disposed on a transmission path of the primary light beam 222 shifted by the light guide element 240. The thermal dissipation element 250 is, for example, a heat sink.

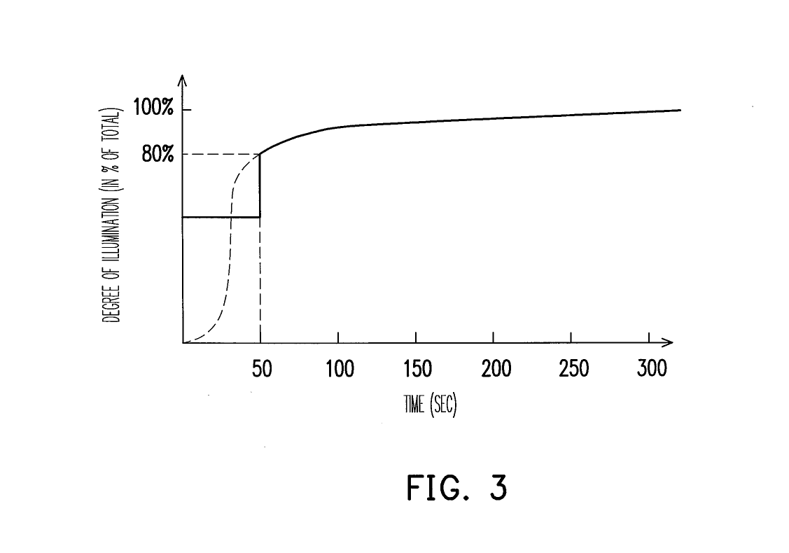

Referring to FIG. 3, in the present embodiment, within a certain period (for example, 50 seconds) after turning on the optical projection apparatus 100, the auxiliary light source 230 is used as the illumination light source for the optical projection apparatus 100. Although a maximum light-emitting luminance of the auxiliary light source 230 is less than that of the primary light source 220, however, it provides an illumination light beam with an appropriate luminance instantly after turning on the optical projection apparatus 100, which allows a user to be able to watch images quickly after the optical projection apparatus 100 is turned on. On the other hand, as the light-emitting luminance of the primary light source 220 reaches to a certain preset light-emitting luminance (for example, to 80% of the maximum light-emitting luminance thereof), the primary light source 220 begins to provide the illumination light beam for the optical projection apparatus 100 to produce images with a higher brightness and replaces the auxiliary light source 230.

Note that the auxiliary light source 230 is only illuminating during a short duration after turning on the optical projection apparatus 100, therefore, the auxiliary light source 230 is not likely to malfunction even though the auxiliary light source 230 has a shorter lifespan. For example, based on the average lifespan of the auxiliary light source 230 is 500 hours and the optical projection apparatus 100 is supposed to be turned on five times a day with 60 seconds of working time for every time turned on, a simple calculation suggests that the auxiliary light source 230 can last for 6000 days. That is, the effective usage time for the auxiliary light source 230 is to exceed 10 years.

### The Second Embodiment

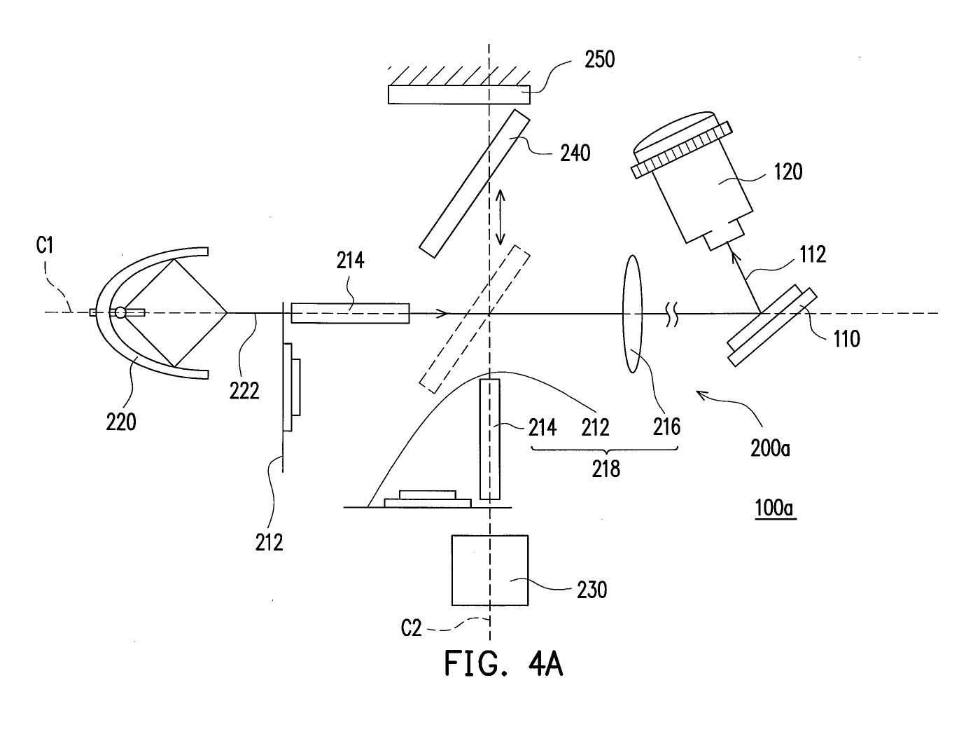

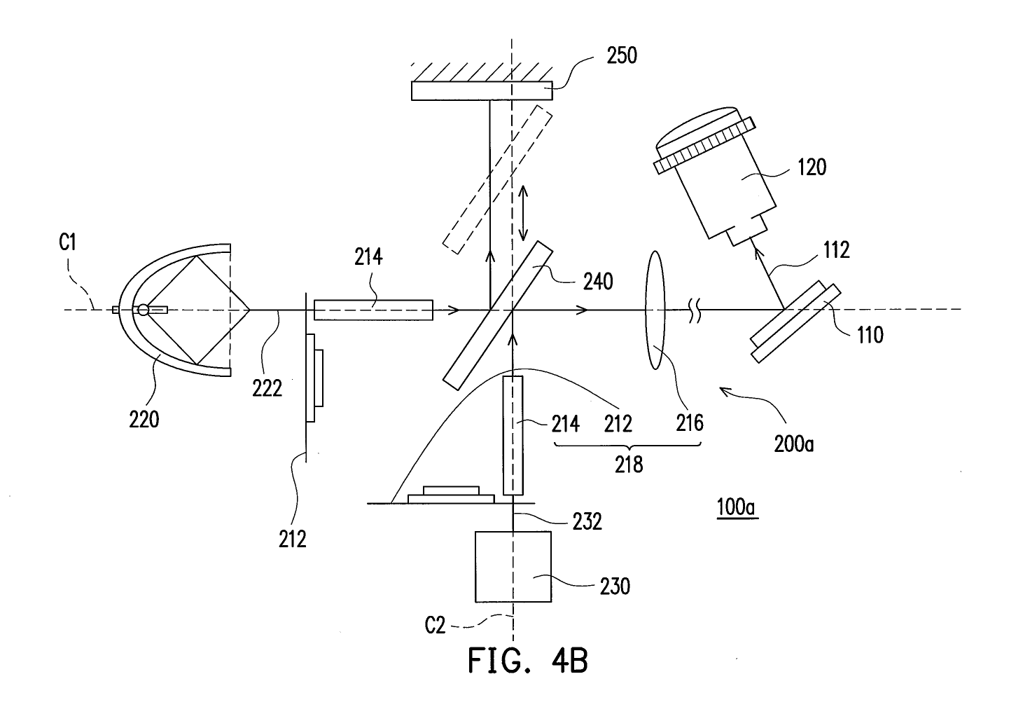

FIG. 4A and FIG. 4B are schematic diagrams showing an optical projection apparatus 100a according to a second embodiment of the present invention. Referring to FIGS. 4A and 4B, the optical projection apparatus 100a is similar to the optical projection apparatus 100 in FIGS. 2A and 2B, except that the illumination system 200a in the optical projection apparatus 100a has two color wheels 212 and two light integration rods 214. The primary light beam 222 provided by the primary light source 220 is passing through a set of a color wheel 212 and a light integration rod 214, while the auxiliary light beam 232 provided by the auxiliary light source 230 is passing through another set of a color wheel 212 and a light integration rod 214. The light guide element 240 is disposed adjacent to the light exiting end of the light integration rod 214. The primary light beam 222 and the auxiliary light beam 232 processing are made by the light guide element 240 after they respectively passing through the sets of the color wheel 212 and the light integration rod 214.

### The Third Embodiment

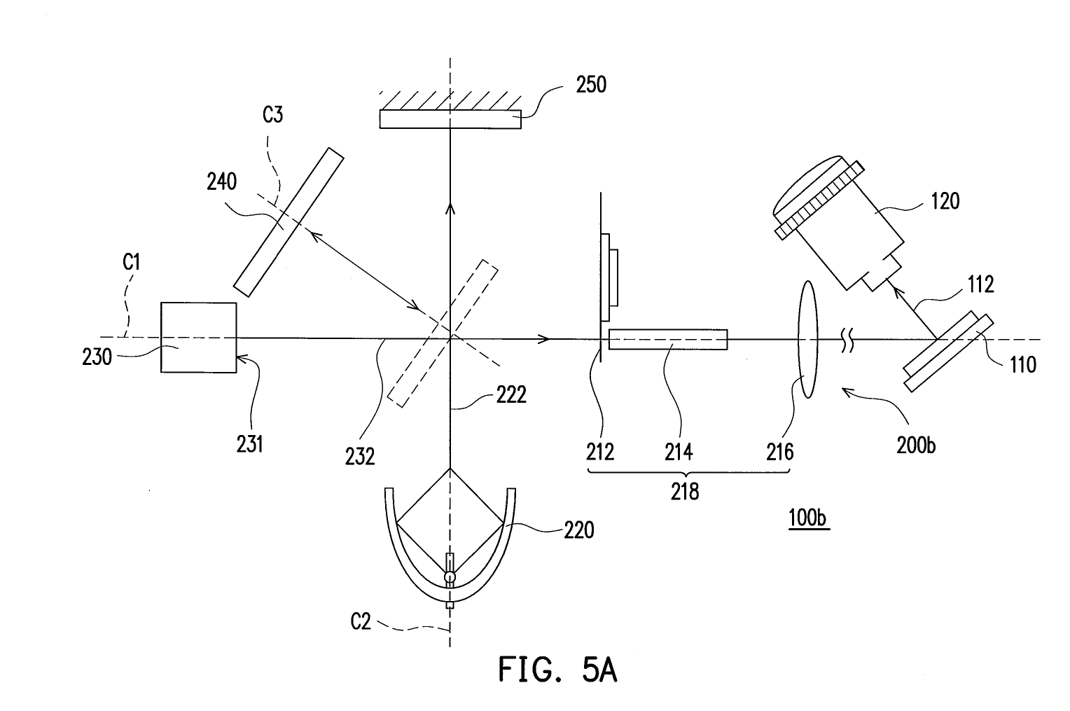

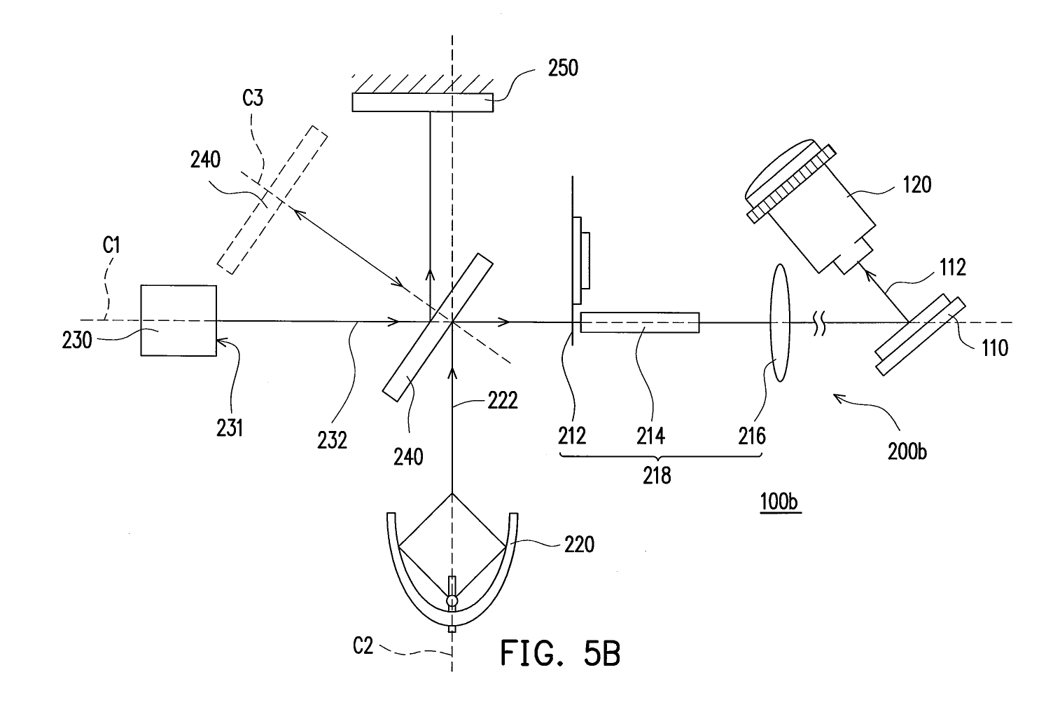

FIG. 5A and FIG. 5B are schematic diagrams showing an optical projection apparatus 100b according to a third embodiment of the present invention. Referring to FIGS. 2A, 2B, 5A, and 5B, the optical projection apparatus 100b is similar to the optical projection apparatus 100 except that in the illumination system 200b of the optical projection apparatus 100b, the positions of the primary light source 220 and the auxiliary light source 230 are different from the optical projection apparatus 100 by interchanging the positions thereof in the illumination system 200. In other words, in the illumination system 200b, the primary light source 220 is disposed on the second axis C2, while the auxiliary light source 230 is disposed on the first axis C1, and the auxiliary light source 230 possesses a light emitting section 231 opposite to the light incident end of the color wheel 212. Furthermore, the light guide element 240 moves along a third axis C3 to shift in or away from the transmission paths of the primary light beam 222 and the auxiliary light beam 232.

Referring to FIG. 5A, as the optical projection apparatus 100b is turned on, the primary light source 220 and the auxiliary light source 230 are simultaneously turned on. Since the primary light source 220 has insufficient light-emitting luminance, the auxiliary light source 230 provides the optical projection apparatus 100b with a required illumination light beam. Therefore, the actuator enables the light guide element 240 to be shifted away from the transmission paths of the primary light beam 222 and the auxiliary light beam 232, and enables the auxiliary light beam 232 to be transmitted to the optical elements 218, which includes the color wheel 212, the light integration rod 214, and the lens 216. At this point, the auxiliary light source 230 provides the optical projection apparatus 100b with a required illumination light beam. In addition, a thermal dissipation element 250 is disposed on the transmission path of the primary light beam 222 after the light guide element 240 is shifted away from the primary light beam 222 to further cool down the optical projection apparatus 100b.

Referring to FIG. 5B, as the light-emitting luminance of the primary light source 220 is reached to an extent higher than that of the auxiliary light source 230 or to a certain preset light-emitting luminance (for example, to 80% of the maximum light-emitting luminance thereof), the actuator enables the light guide element 240 to be shifted in the transmission paths of the primary light beam 222 and the auxiliary light beam 232, such that the primary light beam 222 is transmitted to the optical elements 218, which includes the color wheel 212, the light integration rod 214, and the lens 216. Thus, the primary light source 220 begins with the providing of the optical projection apparatus 100b with a required illumination light beam.

In the embodiment, as the actuator enables the light guide element 240 to be shifted in the transmission paths of the primary light beam 222 and the auxiliary light beam 232, the auxiliary light source 230 is shut off or the auxiliary light beam 232 is guided by the light guide element 240 to the thermal dissipation element 250.

### The Fourth Embodiment

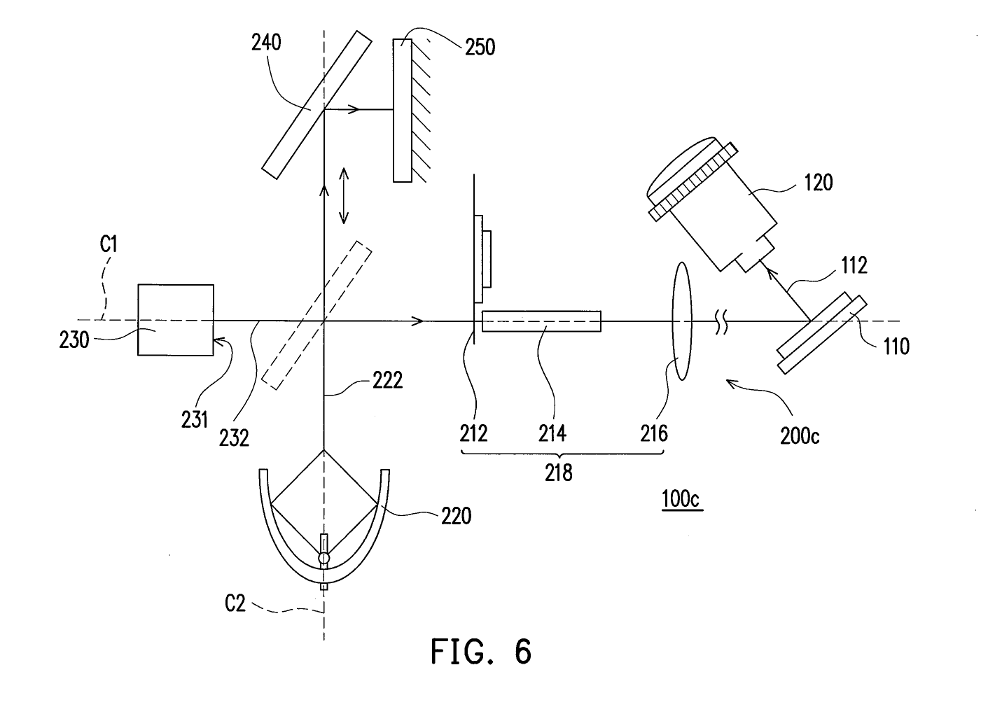

FIG. 6 is a schematic diagram showing an optical projection apparatus 100c according to the fourth embodiment of the present invention. Referring to FIG. 6, the illumination system 200c herein is different from the illumination system 200b of the optical projection apparatus 100b in FIG. 5A. In the illumination system 200c of the optical projection apparatus 100c in FIG. 6, the light guide element 240 moves along the second axis C2 for being shifted in or away from the transmission paths of the primary light beam 222 and the auxiliary light beam 232. As the light guide element 240 is shifted away from the transmission paths of the primary light beam 222 and the auxiliary light beam 232, the light guide element 240 is located on the transmission path of the primary light beam 222 for guiding the primary light beam 222 to the thermal dissipation element 250, and the auxiliary light beam 232 is transmitted to the optical elements 218.

In summary, the optical projection apparatus of the present invention and the illumination system thereof have at least the following advantages:

1. Since the present invention employs an auxiliary light source capable of instantly reaching the maximum light-emitting luminance and providing the illumination system with an appropriate luminance at the beginning of turning on the illumination system, the present invention is consequently able to improve upon the drawback of a conventional optical projection apparatus failing to promptly display images after turning on the same.

2. As the light-emitting luminance of the primary light source reaches a certain extent, the primary light source is on duty to provide the required illumination light beam, which enables the optical projection apparatus to produce brighter images on the screen.

3. Since the auxiliary light source works for a tiny duration every time after the optical projection apparatus is turned on, hence the auxiliary light source is still adequately reliable having no failure given a shorter lifespan.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An illumination system, comprising:
an optical element, having a light incident end;
a primary light source disposed at a side of the light incident end of the optical element and suitable for providing a primary light beam;
an auxiliary light source disposed at the side of the light incident end of the optical element and suitable for providing an auxiliary light beam, the primary light source having a duration for reaching the maximum light-emitting luminance thereof longer than that of the auxiliary light source after turning on the primary light source; and
a light guide element suitable for being shifted in or away from the transmission paths of the primary light beam and the auxiliary light beam for the primary light beam and the auxiliary light beam being transmitted to the optical element, alternatively.

2. The illumination system as recited in claim 1, wherein the maximum light-emitting luminance of the primary light source is higher than the maximum light-emitting luminance of the auxiliary light source.

3. The illumination system as recited in claim 2, wherein the primary light source possesses an light emitting section, the light emitting section of the primary light source is opposite to the light incident end of the optical element, and as the primary light source and the auxiliary light source are turned on, the light guide element is shifted in the transmission paths of the primary light beam and the auxiliary light beam to enable the auxiliary light beam to be transmitted to the optical element and the primary light beam to be shifted away from the optical element, and as the light-emitting luminance of the primary light source is higher than that of the auxiliary light source, the light guide element is shifted away from the transmission paths of the primary light beam and the auxiliary light beam to enable the primary light beam to be transmitted to the optical element.

4. The illumination system as recited in claim 3, wherein as the light guide element is shifted away from the transmission paths of the primary light beam and the auxiliary light beam, the auxiliary light source is shut off.

5. The illumination system as recited in claim 3, further comprising a thermal dissipation element disposed on the transmission path of the primary light beam shifted by the light guide element.

6. The illumination system as recited in claim 2, wherein the auxiliary light source possesses an light emitting section, the light emitting section of the auxiliary light source is opposite to the light incident end of the optical element, and as the primary light source and the auxiliary light source are turned on, the light guide element is shifted away from the transmission paths of the primary light beam and the auxiliary light beam to enable the auxiliary light beam to be transmitted to the optical element, and as the light-emitting luminance of the primary light source is higher than that of the auxiliary light source, the light guide element is shifted in the transmission paths of the primary light beam and the auxiliary light beam to enable the primary light beam to be transmitted to the optical element.

7. The illumination system as recited in claim 6, wherein as the light guide element is shifted in the transmission paths of the primary light beam and the auxiliary light beam, the auxiliary light source is shut off.

8. The illumination system as recited in claim 6, further comprising a thermal dissipation element disposed on the transmission path of the primary light beam after the light guide element being shifted away from the transmission paths of the primary light beam and the auxiliary light beam.

9. The illumination system as recited in claim 1, further comprising an actuator connecting the light guide element to enable the light guide element to be shifted in or away from the transmission paths of the primary light beam and the auxiliary light beam.

10. The illumination system as recited in claim 1, wherein the primary light source is an ultra high pressure (UHP) mercury lamp or a xenon lamp, and the auxiliary light source is a light-emitting diode (LED), a halogen lamp, a metal halide lamp (MHL), or a laser diode (LD).

11. The illumination system as recited in claim 1, wherein the light guide element is a reflector, a dichroic mirror, a prism, or a lens set.

12. The illumination system as recited in claim 1, wherein the optical element comprises at least one of a color wheel, a light integration rod, and a lens.

13. An optical projection apparatus, comprising:
an illumination system, comprising:
an optical element having a light incident end;
a primary light source disposed at a side of the light incident end of the optical element and suitable for providing a primary light beam;
an auxiliary light source disposed at the side of the light incident end of the optical element and suitable for providing an auxiliary light beam, a maximum light-emitting luminance of the primary light source being higher than that of the auxiliary light source, and the primary light source having a duration to reach the maximum light-emitting luminance thereof longer than that of the auxiliary light source after turning on the primary light source;
a light guide element suitable for being shifted in or away from the transmission paths of the primary light beam and the auxiliary light beam for the primary light beam and the auxiliary light beam being transmitted to the optical element, alternatively;
a light valve disposed behind the optical element and suitable for converting the incident primary light beam or the incident auxiliary light beam thereon into an image light beam; and
an imaging system disposed on a transmission path of the image light beam.

14. The optical projection apparatus as recited in claim 13, wherein the primary light source possesses an light emitting section, the light emitting section of the primary light source is opposite to the light incident end of the optical element, and as the primary light source and the auxiliary light source are turned on, the light guide element is shifted in the transmission paths of the primary light beam and the auxiliary light beam to enable the auxiliary light beam to be transmitted to the optical element and the primary light beam to be shifted away from the optical element, and as the light-emitting luminance of the primary light source is higher than that of the auxiliary light source, the light guide element is shifted away from the transmission paths of the primary light beam and the auxiliary light beam to enable the primary light beam to be transmitted to the optical element.

15. The optical projection apparatus as recited in claim 14, wherein as the light guide element is shifted away from the transmission paths of the primary light beam and the auxiliary light beam, the auxiliary light source is shut off.

16. The optical projection apparatus as recited in claim 14, further comprising a thermal dissipation element disposed on the transmission path of the primary light beam shifted by the light guide element.

17. The optical projection apparatus as recited in claim 13, wherein the auxiliary light source possesses an light emitting section, the light emitting section of the auxiliary light source is opposite to the light incident end of the optical element, and as the primary light source and the auxiliary light source are turned on, the light guide element is shifted away from the transmission paths of the primary light beam and the auxiliary light beam to enable the auxiliary light beam to be transmitted to the optical element, and as the light-emitting luminance of the primary light source is higher than that of the auxiliary light source, the light guide element is shifted in the transmission paths of the primary light beam and the auxiliary light beam to enable the primary light beam to be transmitted to the optical element.

18. The optical projection apparatus as recited in claim 17, wherein as the light guide element is shifted in the transmission paths of the primary light beam and the auxiliary light beam, the auxiliary light source is shut off.

19. The optical projection apparatus as recited in claim 17, further comprising a thermal dissipation element disposed on the transmission path of the primary light beam after the light guide element being shifted away from the transmission paths of the primary light beam and the auxiliary light beam.

20. The optical projection apparatus as recited in claim 13, wherein the illumination system further comprising an actuator connecting the light guide element to enable the light guide element to be shifted in or away from the transmission paths of the primary light beam and the auxiliary light beam.

21. The optical projection apparatus as recited in claim 13, wherein the primary light source is an ultra high pressure (UHP) mercury lamp or a xenon lamp, and the auxiliary light source is a light-emitting diode (LED), a halogen lamp, a metal halide lamp (MHL), or a laser diode (LD).

22. The optical projection apparatus as recited in claim 13, wherein the light guide element is a reflector, a dichroic mirror, a prism, or a lens set.

23. The optical projection apparatus as recited in claim 13, wherein the optical element comprises at least one of a color wheel, a light integration rod, and a lens.

24. The optical projection apparatus as recited in claim 13, wherein the imaging system comprises a projection lens.
